(19) United States
(12) Patent Application Publication
(10) Pub. No.: US 2015/0333918 A1
(43) Pub. Date: Nov. 19, 2015

(54) POWER OVER ETHERNET ENABLED SENSOR AND SENSOR NETWORK

(71) Applicant: SCHNEIDER ELECTRIC BUILDINGS, LLC, Palatine, IL (US)

(72) Inventor: William Anthony White, III, Carlisle, MA (US)

(73) Assignee: SCHNEIDER ELECTRIC BUILDINGS, LLC, Palatine, IL (US)

(21) Appl. No.: 14/710,718

(22) Filed: May 13, 2015

Related U.S. Application Data
(60) Provisional application No. 61/993,559, filed on May 15, 2014.

(51) Int. Cl. H04L 12/10

(52) U.S. Cl. CPC H04L 12/10

(57) ABSTRACT

According to one aspect, embodiments herein provide a PoE sensor comprising a housing, sensing circuitry disposed within the housing and configured to detect a physical phenomenon outside the housing, at least one internal power source equipment (“PSE”) circuit disposed within the housing and configured to transmit PoE power and data to at least one downstream sensor, and powered device (“PD”) circuitry disposed within the housing, coupled to the sensing circuitry and the at least one internal PSE circuit, and configured to receive PoE power and data from at least one element of PSE external to the housing, transmit PoE power to the sensing circuitry to initiate operation of the sensing circuitry, and transmit PoE power and data to the at least one internal PSE circuit to initiate transmission of PoE power and data to the at least one downstream sensor.

### CROSS REFERENCE TO RELATED APPLICATION

This application claims priority under 35 U.S.C. §119(e) to U.S. Provisional Application Ser. No. 61/993,559 entitled “POWER OVER ETHERNET ENABLED SENSOR AND SENSOR NETWORK,” filed on May 15, 2014, which is incorporated herein by reference in its entirety.

### BACKGROUND

1. Technical Field

The technical field relates generally to building management systems, more particularly, to methods and systems of powering sensors used within building management systems.

2. Background Discussion

Building management systems (BMSs) may include a wide variety of sensors. Examples of these BMS sensors include temperature, humidity, light, CO2, occupancy, and real-time location sensors. BMS sensors enable a BMS to monitor and control building subsystems efficiently and conveniently for stakeholders. In conventional BMS installations, power is supplied to BMS sensors via batteries or distributed grid power.

### SUMMARY

Embodiments disclosed herein reduce cost and increase reliability in supplying power to one or more sensors included in a sensor network via Power-over-Ethernet (PoE). Wireless sensors typically require battery power, which in turn requires a tradeoff between performance (transmit power & update rate) and battery life. Replacing batteries in thousands of sensors is costly and disruptive, even if done infrequently. Providing wired power adds cost to the installation, especially if the wired power is separate from the data wiring. Providing grid power requires substantial cables that can deliver much more power than required by a typical sensor. Other means of powering sensors, such as solar or parasitic power collection (e.g., harvested from vibration) are useful only in very specialized cases.

Power-over-Ethernet (PoE) technology was developed to address the need for a single cable to carry both power and data. There have been several generations of PoE; the first provides up to 15 watts to the powered device, the second (PoE+) provides up to 30 watts, and the latest (UPoE) up to 51 watts. In some examples, the cable is run from a network switch or router to the powered device. As referred to herein, a “powered device” is referred to as a PD and a “power supply” (switch or router in these examples) is referred to as Power Sourcing Equipment (PSE).

Because the power available from the PSE is rarely matched well to the demand of the PD, surplus power is typically available. Devices referred to as PoE Extenders exist to allow a first PD (directly attached to a PSE) to pass along surplus power to other devices, for which the first PD acts as PSE for a next PD in a PoE enabled sensor network. Additional extenders can be added to the system.

The cost of PoE equipment, such as a PoE extender or a PoE port on a switch or router, is significant—conventionally much more than the cost of sensors powered by the PoE equipment. PoE extenders help to share the cost of a PoE port among the devices in a PoE enabled sensor network, but as conventionally priced, PoE equipment is typically unsuitable for powering a sensor network in a building. Embodiments disclosed herein manifest an appreciation for these shortcomings.

Aspects in accord with the present invention are directed to a Power over Ethernet (“PoE”) sensor comprising a housing, sensing circuitry disposed within the housing and configured to detect a physical phenomenon outside the housing, at least one internal power source equipment (“PSE”) circuit disposed within the housing and configured to transmit PoE power and data to at least one downstream sensor, and powered device (“PD”) circuitry disposed within the housing, coupled to the sensing circuitry and the at least one internal PSE circuit, and configured to receive PoE power and data from at least one element of PSE external to the housing, transmit PoE power to the sensing circuitry to initiate operation of the sensing circuitry, and transmit PoE power and data to the at least one internal PSE circuit to initiate transmission of PoE power and data to the at least one downstream sensor.

According to one embodiment, the sensing circuitry is further configured to transmit data corresponding to the physical phenomenon to the at least one internal PSE circuit and the PD circuitry. In another embodiment, the sensing circuitry is further configured to detect the physical phenomenon including at least one of temperature, humidity, vibration, and ambient light levels. In one embodiment, the PD circuitry is further configured to transmit data to the at least one element of PSE external to the housing.

According to another embodiment, the at least one internal PSE circuit includes a first internal PSE circuit coupled to the PD circuitry and the sensing circuitry, the first internal PSE circuit configured to transmit PoE power and data to a first downstream sensor, and a second internal PSE circuit coupled to the PD circuitry and the sensing circuitry, the second internal PSE circuit configured to transmit PoE power and data to a second downstream sensor. In one embodiment, the at least one internal PSE circuit is further configured to receive data from the at least one downstream sensor. In another embodiment, the at least one internal PSE circuit is further configured to transmit data received from the at least one downstream sensor to the PD circuitry.

According to one embodiment, the PoE sensor further comprises a super capacitor coupled to the PD circuitry, the at least one internal PSE circuit, and the sensing circuitry, wherein the super capacitor is configured to supplement the PoE power transmitted by the PD circuitry to the at least one internal PSE circuit and the sensing circuitry. In one embodiment, the PD circuitry is further configured to receive PoE power derived from a backup power source.

According to another embodiment, the PoE sensor further comprises a PoE injector coupled to the PD circuitry, the sensing circuitry, and the at least one internal PSE circuit, wherein the PoE injector is configured to receive mains power from a mains power source and transmit the mains power to the sensing circuitry and the at least one internal PSE circuit. In one embodiment, the PoE injector is further configured to communicate data between the PD circuitry and at least one of the sensing circuitry and the at least one internal PSE circuit. In another embodiment, the PD circuitry is further configured to receive PoE power from an external PoE injector and to transmit data to an upstream sensor via the external PoE injector. In one embodiment, the PD circuitry is further configured to transmit data to an upstream sensor via the external PoE injector.

Another aspect in accord with the present invention is directed to a sensor network comprising a plurality of PoE sensors, each PoE sensor comprising a housing, sensing circuitry disposed within the housing and configured to detect a physical phenomenon outside the housing, at least one internal PSE circuit disposed within the housing and coupled to the sensing circuitry, and PD circuitry disposed within the housing and coupled to the sensing circuitry and the at least one internal PSE circuit, wherein the at least one internal PSE circuit is configured to be coupled to the PD circuitry of at least one downstream PoE sensor of the plurality of PoE sensors and to transmit PoE power and data to the at least one downstream PoE sensor of the plurality of PoE sensors, and wherein the PD circuitry is configured to be coupled to the at least one internal PSE circuit of an upstream PoE sensor of the plurality of PoE sensors, and is further configured to receive PoE power and data from the at least one internal PSE circuit of the upstream PoE sensor, transmit PoE power to the sensing circuitry to initiate operation of the sensing circuitry, and transmit PoE power and data to the at least one internal PSE circuit to initiate transmission of PoE power and data to the at least one downstream PoE sensor of the plurality of PoE sensors. In one embodiment, the plurality of PoE sensors are coupled together in a binary tree configuration.

According to one embodiment, the sensor network further comprises a backup power source coupled to the PD circuitry of at least one of the plurality of PoE sensors, wherein the PD circuitry of the at least one of the plurality of PoE sensors is configured to receive PoE power derived from the backup power source.

According to another embodiment, the sensor network further comprises a mains power source, and a PoE injector coupled to the mains power source, the at least one internal PSE circuit of a first one of the plurality of PoE sensors, and the PD circuitry of a second one of the plurality of PoE sensors, wherein the at least one internal PSE circuit of the first one of the plurality of PoE sensors is configured to provide a reduced power PoE signal to the PoE injector, and wherein the PoE injector is configured to receive mains power from the mains power source and provide a full strength PoE signal to the PD circuitry of the second one of the plurality of PoE sensors derived from the mains power and the reduced power PoE signal. In one embodiment, the PoE injector is further configured to communicate data between the at least one internal PSE circuit of the first one of the plurality of PoE sensors and the PD circuitry of the second one of the plurality of PoE sensors.

According to one embodiment, at least one of the plurality of PoE sensors further comprises a super capacitor coupled to the PD circuitry, the at least one internal PSE circuit, and the sensing circuitry, and wherein the super capacitor is configured to supplement the PoE power transmitted by the PD circuitry to the at least one internal PSE circuit and the sensing circuitry.

At least one aspect of the present invention is directed to a PoE sensor comprising a housing, sensing circuitry disposed within the housing and configured to detect a physical phenomenon outside the housing, PD circuitry disposed within the housing and coupled to the sensing circuitry, the PD circuitry configured to receive PoE power and data from at least one element of PSE external to the housing, and transmit PoE power to the sensing circuitry to initiate operation of the sensing circuitry, and means for incorporating PoE extender capability into the PoE sensor such that the PoE sensor is configured to transmit PoE power and data to another downstream PoE sensor.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic diagram of a PoE enabled sensor within a sensor network in accordance with aspects of the present invention;

FIG. 2 is a schematic diagram of PoE enabled sensors within a flat sensor network in accordance with aspects of the present invention;

FIG. 3 is a schematic diagram of another PoE enabled sensor within a hierarchical sensor network in accordance with aspects of the present invention;

FIG. 4 is a schematic diagram of another PoE enabled sensor within a sensor network in accordance with aspects of the present invention;

FIG. 5 is a schematic diagram of a hierarchical sensor network with backup power in accordance with aspects of the present invention;

FIG. 6 is a schematic diagram of a hierarchical sensor network a PoE injector in accordance with aspects of the present invention;

FIG. 7 is a schematic diagram of another hierarchical sensor network a PoE injector in accordance with aspects of the present invention.

FIG. 8 is a graph illustrating a comparison of growth of Cₐ vs. node count in a small linear network and a binary tree network in accordance with aspects of the present invention;

FIG. 9 is a graph illustrating a comparison of growth of Cₐ vs. node count in a large linear network and a binary tree network in accordance with aspects of the present invention;

FIG. 10 is a graph illustrating the value of k_{eq} for a range of network sizes;

FIG. 11 is a graph illustrating a comparison of the probability of node losses from a single failure in a small linear network and a small binary tree network in accordance with aspects of the present invention; and

FIG. 12 is a graph illustrating a comparison of the probability of node losses from a single failure in a large linear network and a large binary tree network in accordance with aspects of the present invention.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples or embodiments are not intended to be excluded from a similar role in any other examples or embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

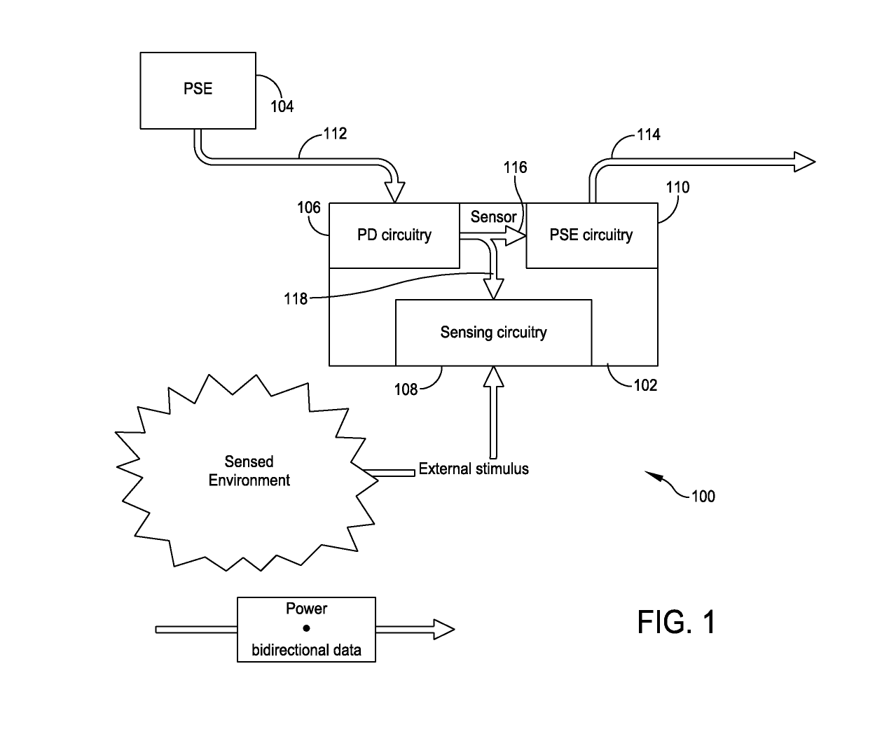

FIG. 1 illustrates a PoE enabled sensor network 100 according to one embodiment. As shown in FIG. 1, the PoE enabled sensor network 100 includes a PoE enabled sensor 102, PSE 104, and connections 112 and 114. The PoE enabled sensor 102 includes PD circuitry 106, sensing circuitry 108, PSE circuitry 110, and connections 116 and 118.

In one embodiment illustrated by FIG. 1, the PSE 104 is coupled to the PoE enabled sensor 102 by the connection 112. In this embodiment, the PSE 104 supplies power to drive the operation of the PoE enabled sensor 102 via the connection 112. Also, according to this embodiment, the PSE 104 and the PoE enabled sensor 102 communicate data via the connection 112. More specifically, as shown in FIG. 1, the PSE 104 communicates data and supplies power to the PD circuitry 106. The data communicated to the PSE 104 by the PoE enabled sensor 102 via the PD circuitry 106 may include information descriptive of the environment of the PoE enabled sensor 102 as described below.

In this embodiment, the PD circuitry 106, in turn, is coupled to the sensing circuitry 108 by the connection 118. The PD circuitry 106 supplies power to drive the operation of the sensing circuitry 108 via the connection 118. Also, according to this embodiment, the PD circuitry 106 and the sensing circuitry 108 communicate data via the connection 118. This data may be descriptive of any physical phenomenon detectable by the sensing circuitry 108. Examples of detectable physical phenomenon include temperature, humidity, vibration, ambient light levels, and other physical phenomenon. As shown in FIG. 1, the data may describe the environment of the PoE enabled sensor 102 as detected in response to receipt of external stimulus by the sensing circuitry 108.

In this embodiment, the PD circuitry 106 is also coupled to the PSE circuitry 110 by the connection 116. The PD circuitry 106 supplies power and communicates data to the PSE circuitry 110 via the connection 116. The PSE circuitry 110, in turn, supplies power and communicates data to the next sensor in the PoE enabled sensor network 100 via the connection 114.

By incorporating a PoE extender capability directly into the sensor via the PSE circuitry 110, cost is greatly reduced and sufficient power can be supplied to the sensors without the need for batteries. A data cable to each sensor is all that is required for both power and data to be transmitted.

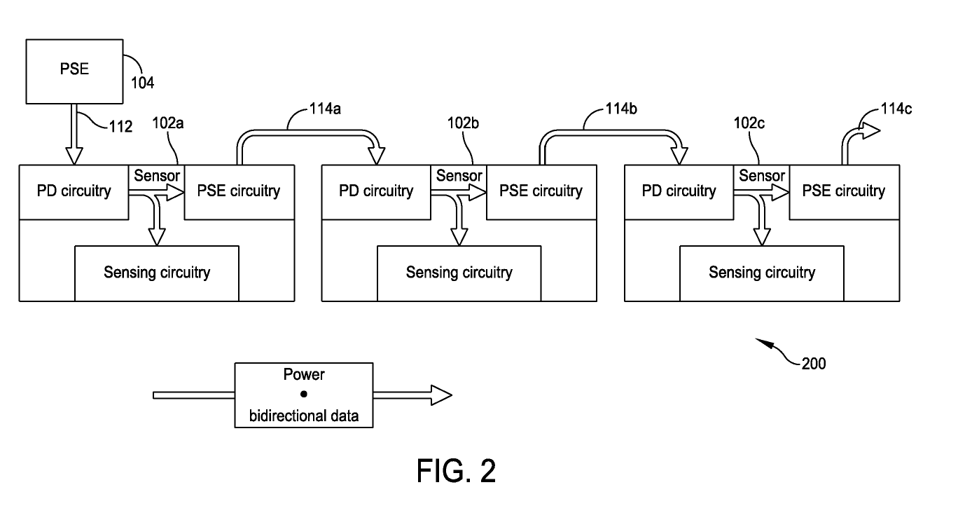

FIG. 2 illustrates a PoE enabled sensor network 200 according to another embodiment. As shown in FIG. 2, the PoE enabled sensor network 200 includes a plurality of PoE enabled sensors 102a-102c connected in series, PSE 104, and connections 112 and 114a-114c. Each of the PoE enabled sensors 102a-102c is arranged in accord with, and includes the same features as, the PoE enabled sensor 102 described above with reference to FIG. 1.

In one embodiment illustrated by FIG. 2, the PSE 104 is coupled to the PoE enabled sensor 102 by the connection 112. In this embodiment, the PSE 104 supplies power and communicates data to the PoE enabled sensor 102a via the connection 112. Also, according to this embodiment, the PoE enabled sensor 102a receives power and data from the PSE 104 and provides power and data to the PoE enabled sensor 102b. Also, according to this embodiment, the PoE enabled sensor 102b receives power and data from the PoE enabled sensor 102a and provides power and data to the PoE enabled sensor 102c. Also, according to this embodiment, the PoE enabled sensor 102c receives power and data from the PoE enabled sensor 102b and provides power and data to the next sensor in the PoE enabled sensor network 200.

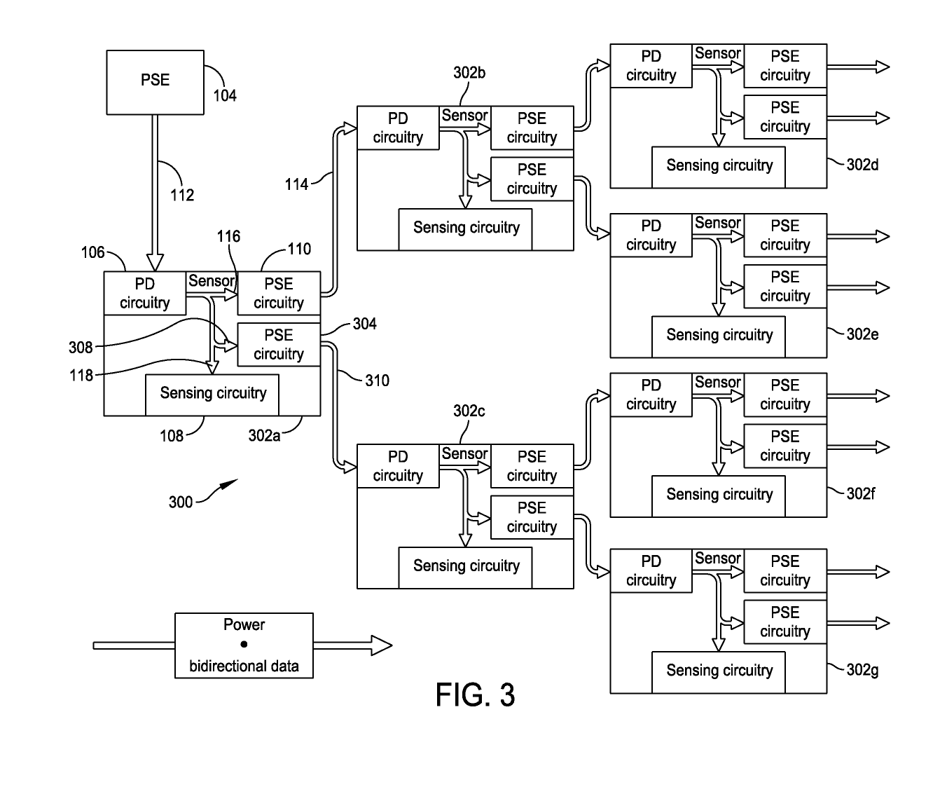

FIG. 3 illustrates a PoE enabled sensor network 300 according to another embodiment. As shown in FIG. 3, the PoE enabled sensor network 300 includes a plurality of PoE enabled sensors 302a-302g connected in a tree configuration that includes PSE 104 and connections 112, 114, and 310 among others. As shown in FIG. 3, the PoE enabled sensor 302a includes PD circuitry 106, sensing circuitry 108, PSE circuitries 110 and 304, and connections 116, 118, and 308.

In one embodiment illustrated by FIG. 3, the PSE 104 is coupled to the PoE enabled sensor 302a by the connection 112. In this embodiment, the PSE 104 supplies power to drive the operation of the PoE enabled sensor 302a via the connection 112. Also, according to this embodiment, the PSE 104 and the PoE enabled sensor 302a communicate data via the connection 112. More specifically, as shown in FIG. 3, the PSE 104 communicates data and supplies power to the PD circuitry 106. The data communicated to the PSE 104 by the PoE enabled sensor 302a via the PD circuitry 106 may include information descriptive of the environment of the PoE enabled sensor 302a as described below.

In this embodiment, the PD circuitry 106, in turn, is coupled to the sensing circuitry 108 by the connection 118. The PD circuitry 106 supplies power to drive the operation of the sensing circuitry 108 via the connection 118. Also, according to this embodiment, the PD circuitry 106 and the sensing circuitry 108 communicate data via the connection 118. This data may be descriptive of any physical phenomenon detectable by the sensing circuitry 108. Examples of detectable physical phenomenon include temperature, humidity, vibration, ambient light levels, and other physical phenomenon.

In this embodiment, the PD circuitry 106 is also coupled to the PSE circuitry 110 by the connection 116. The PD circuitry 106 supplies power and communicates data to the PSE circuitry 110 via the connection 116. The PSE circuitry 110, in turn, supplies power and communicates data to the PoE enabled sensor 302b via the connection 114. Also, in this embodiment, the PD circuitry 106 is also coupled to the PSE circuitry 304 by the connection 308. The PD circuitry 106 supplies power and communicates data to the PSE circuitry 304 via the connection 308. The PSE circuitry 304, in turn, supplies power and communicates data to the PoE enabled sensor 302c via the connection 310.

In this embodiment, each of the PoE enabled sensors 302b-302g is arranged in accord with, and includes the same features as, the PoE enabled sensor 302a as described above. In addition, the PoE enabled sensor 302b supplies power and communicates data to the PoE enabled sensors 302d and 302e via the connections between the three sensors illustrated in FIG. 3. Moreover, the PoE enable sensor 302c supplies power and communicates data to the PoE enabled sensors 302f and 302g via the connections between the three sensors illustrated in FIG. 3.

By including two sets of PSE circuitry in each sensor, embodiments disclosed herein enable a PoE enabled sensor network to be arranged as a binary tree of sensors. Under this arrangement, the reliability of the PoE enabled sensor network is enhanced because a failure at any sensor will affect only half of the network from that sensor's parent. In a linear network of N sensors, the probability that a random failure will disable half or more of the network is 50%, regardless of N. In the binary tree network of N sensors, the likelihood of a random failure disabling half (actually half minus 1) or more of the network is 3/N, with a 75% probability of disabling only three or fewer sensors.

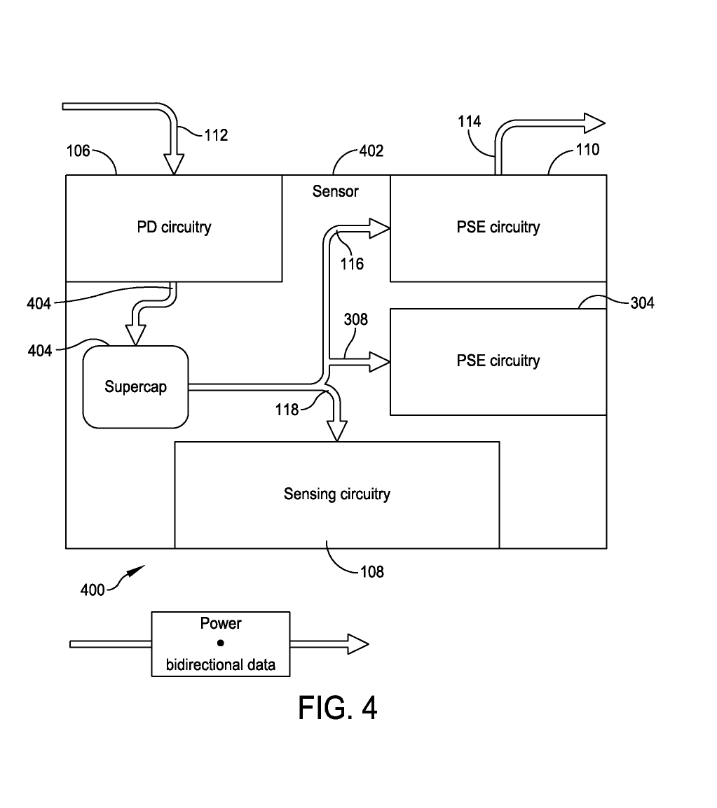

FIG. 4 illustrates a PoE enabled sensor network 400 according to another embodiment. As shown in FIG. 4, the PoE enabled sensor network 400 includes a PoE enabled sensor 402 and connections 112 and 114. As illustrated in FIG. 4, the PoE enabled sensor 402 includes PD circuitry 106, sensing circuitry 108, PSE circuitries 110 and 304, a super capacitor 404, and connections 116, 118, 308, and 404.

In one embodiment illustrated by FIG. 4, a PSE is coupled to the PoE enabled sensor 402 by the connection 112. In this embodiment, the PSE 104 supplies power to drive the operation of the PoE enabled sensor 402 via the connection 112. Also, according to this embodiment, the PSE and the PoE enabled sensor 402 communicate data via the connection 112. More specifically, as shown in FIG. 4, the PSE communicates data and supplies power to the PD circuitry 106. The data communicated to the PSE by the PoE enabled sensor 402 via the PD circuitry 106 may include information descriptive of the environment of the PoE enabled sensor 402 as described below.

In this embodiment, the PD circuitry 106, in turn, is coupled to the super capacitor 404 by the connection 406. The PD circuitry 106 supplies power to charge the super capacitor 404 via the connection 406. In addition, in this embodiment, the PD circuitry 106 and the super capacitor 404 are coupled to the sensing circuitry 108 by the connection 118. The PD circuitry 106 supplies power to drive the operation of the sensing circuitry 108 via the connection 118 and the super capacitor 404 supplements the power supplied by the PD circuitry 106 as needed. Also, according to this embodiment, the PD circuitry 106 and the sensing circuitry 108 communicate data via the super capacitor 404 and the connection 118. This data may be descriptive of any physical phenomenon detectable by the sensing circuitry 108. Examples of detectable physical phenomenon include temperature, humidity, vibration, ambient light levels, and other physical phenomenon.

In this embodiment, the PD circuitry 106 and the super capacitor 404 are coupled to the PSE circuitry 110 by the connection 116. The PD circuitry 106 and the super capacitor 404 supply power and communicate data to the PSE circuitry 110 via the connection 116. The PSE circuitry 110, in turn, supplies power and communicates data to the next sensor in the PoE enabled sensor network 400 via the connection 114. Also, in this embodiment, the PD circuitry 106 and the super capacitor 404 are coupled to the PSE circuitry 304 by the connection 308. The PD circuitry 106 and the super capacitor 404 supply power and communicate data to the PSE circuitry 304 via the connection 308. The PSE circuitry 304, in turn, supplies power and communicates data to the next sensor in the PoE enabled sensor network 400.

By including a super capacitor in at least some of the sensors, the sensor network can be sized to more efficiently to use the full power available from the primary PSE (network switch or router) based on the average power consumption of the sensors. Without the super capacitor, the power budget must consider that all sensors might need maximum power simultaneously. With the super capacitor, when a sensor requires peak power (e.g., for wireless transmission, data transmission, or signal processing), the sensor can draw power from the super capacitor as well as the PSE directly.

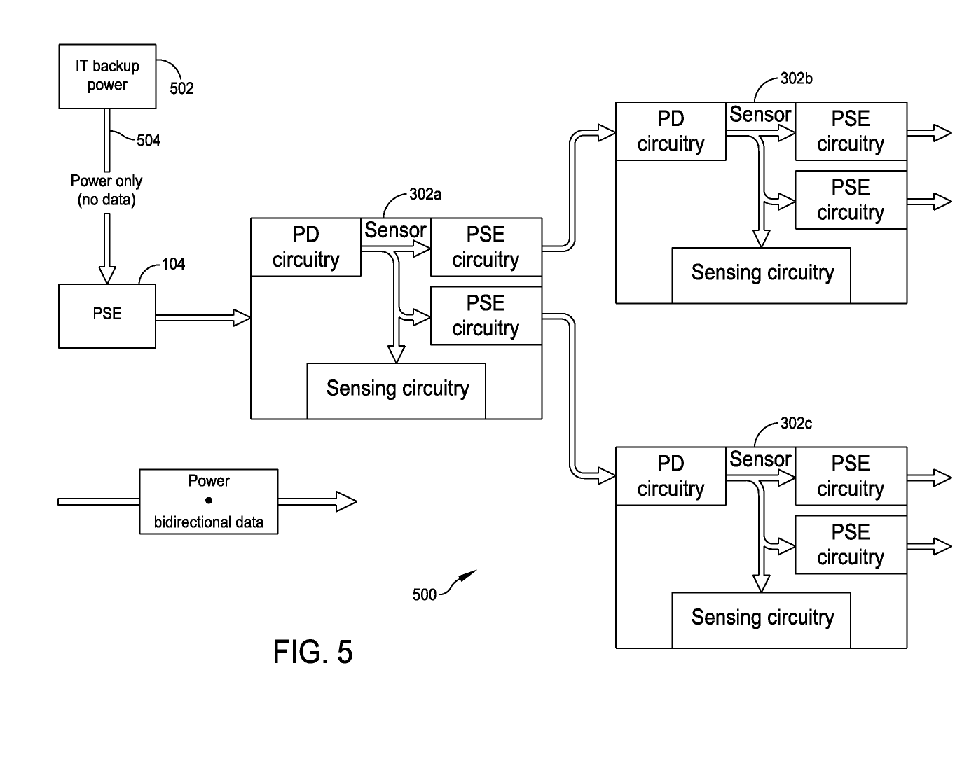

FIG. 5 illustrates a PoE enabled sensor network 500 according to another embodiment. As shown in FIG. 5, the PoE enabled sensor network 500 includes a plurality of PoE enabled sensors 302a-302c connected in a tree configuration that includes PSE 104, IT backup power source 502, and connection 504, among others.

In one embodiment illustrated by FIG. 5, the IT backup power source 502, which may be a battery, generator, uninterruptible power supply, or other device for providing backup power, is coupled to the PSE 104 by the connection 504. In this embodiment, the IT backup power source 502 supplies backup power to the PSE 104 when grid power is not available. Also in this embodiment, the PSE 104 receives power from the IT backup power source 502 and supplies power and communicates data to the PoE enabled sensor 302a as described above with reference to FIG. 3.

In this embodiment, each of the PoE enabled sensors 302a-302c is arranged in accord with, and includes the same features as, the PoE enabled sensor 302a as described above with reference to FIG. 3. In addition, the PoE enabled sensor 302a supplies power and communicates data to the PoE enabled sensors 302b and 302c via the connections between the three sensors illustrated in FIG. 5.

By integrating the sensor system with IT power backup systems such as those offered by Schneider Electric Inc., the system has reduced vulnerability to power outages, as compared with grid-powered sensor systems.

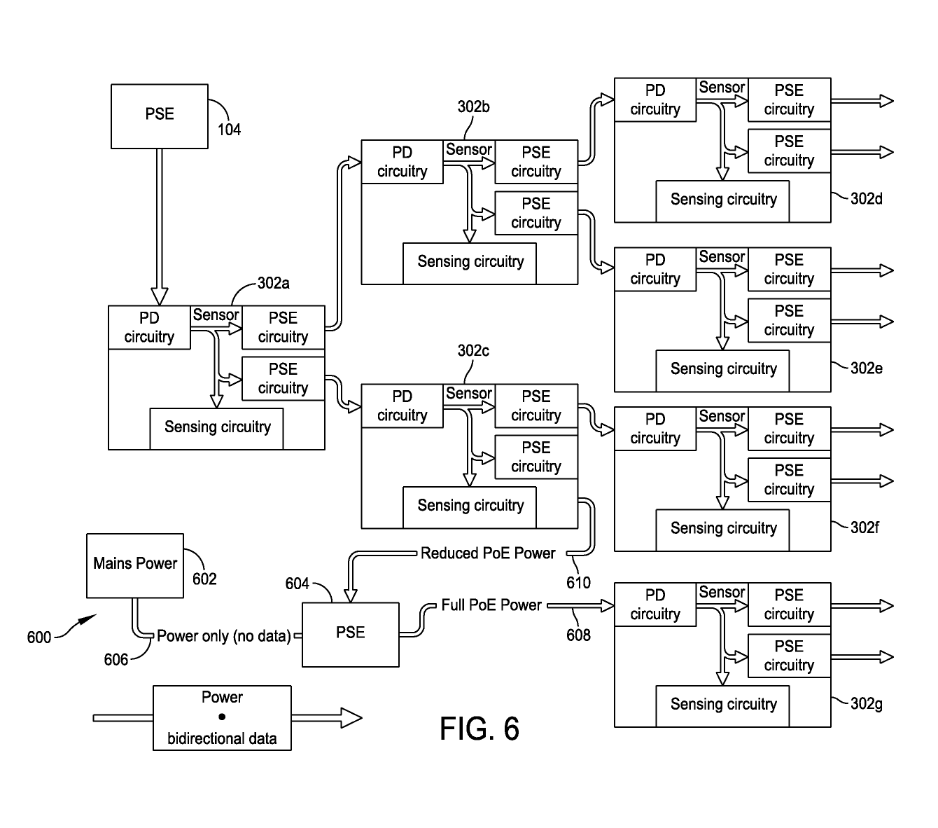

FIG. 6 illustrates a PoE enabled sensor network 600 according to another embodiment. As shown in FIG. 6, the PoE enabled sensor network 600 includes a plurality of PoE enabled sensors 302a-302g connected in a tree configuration that includes PSE 104, grid power source 602, PoE injector 604, and connections 608 and 610, among others.

In one embodiment illustrated by FIG. 6, the PSE 104 and each of the PoE enabled sensors 302a, 302b, and 302d-302g is arranged in accord with, and includes the same features as, the PSE 104 and each of the PoE enabled sensors 302a, 302b, and 302d-302g described above with reference to FIG. 3. In addition, the PoE enabled sensor 302a supplies power and communicates data to the PoE enabled sensors 302b and 302c via the connections between the three sensors illustrated in FIG. 6. Moreover, the PoE enable sensor 302c supplies power and communicates data to the PoE enabled sensor 302f via the connections between the two sensors illustrated in FIG. 6.

Also, in this embodiment, the grid power 602 is coupled to the PoE injector 604 by the connection 606. In this embodiment, the grid power 602 supplies power to drive the operation of the PoE injector 604 via the connection 606. Also, according to this embodiment, the PoE enabled sensor 302c is coupled to the PoE injector 604 by the connection 610. In this embodiment, the PoE enabled sensor 302c supplies power to drive the operation of the PoE injector 604 via the connection 610. Also, in this embodiment, the PoE enabled sensor 302c communicates data to the PoE injector 604 via the connection 610. In addition, according to this embodiment, the PoE injector 604 is coupled to the PoE enabled sensor 302g by the connection 608. In this embodiment, the PoE injector 604 supplies power and communicates data to the PoE enabled sensor 302g via the connection 608.

By adding PoE injectors to the sensor network, the sensor network can be extended beyond the power limits of the primary PSE. These PoE injectors can be added wherever grid power is conveniently near a sensor or sensor cable, rather than having to run grid power to the sensor; this considerably reduces the cost of providing grid power to the sensor network. In some embodiments where PoE injectors are used, the IT power backup will not be available for portions the sensor network powered by PoE injectors.

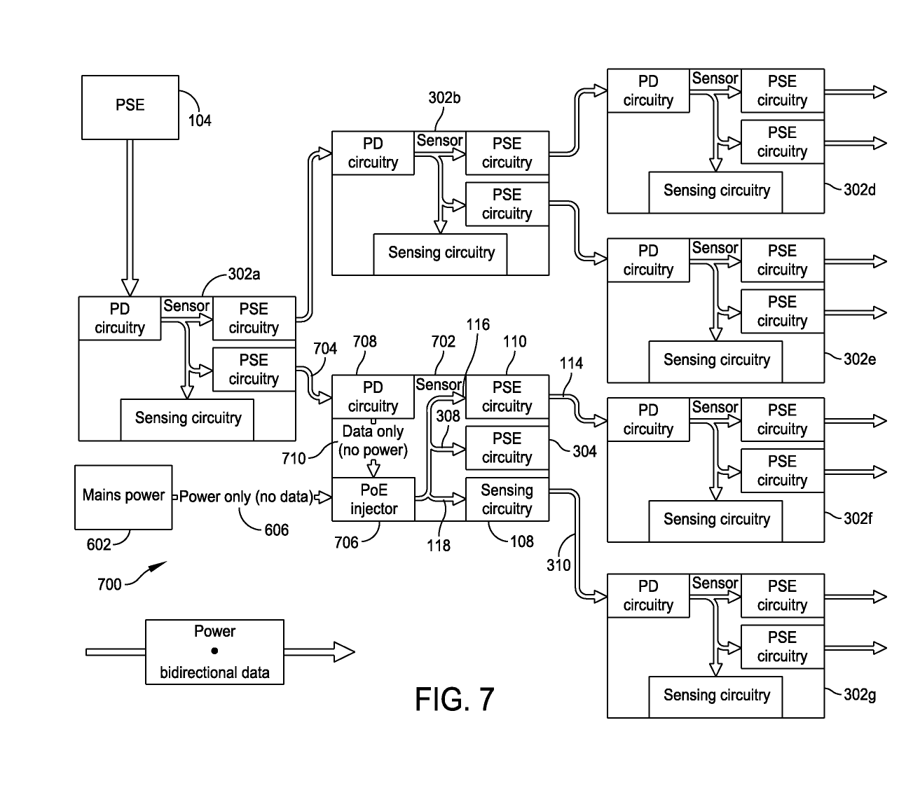

FIG. 7 illustrates a PoE enabled sensor network 700 according to another embodiment. As shown in FIG. 7, the PoE enabled sensor network 700 includes a plurality of PoE enabled sensors 302a, 302b, 302d-302g and 702 connected in a tree configuration that includes PSE 104, grid power source 602, PoE injector 706, and connection 606, among others. As shown in FIG. 7, the PoE enabled sensor 702 includes PD circuitry 708, sensing circuitry 108, PoE injector 706, PSE circuitries 110 and 304, and connections 116, 118, and 308.

In one embodiment illustrated by FIG. 7, the PSE 104 and each of the PoE enabled sensors 302a, 302b, and 302d-302g is arranged in accord with, and includes the same features as, the PSE 104 and each of the PoE enabled sensors 302a, 302b, and 302d-302g described above with reference to FIG. 3. In addition, the PoE enabled sensor 302a supplies power and communicates data to the PoE enabled sensors 302b via the connections between the two sensors illustrated in FIG. 7. Moreover, the PoE enable sensor 702 supplies power and communicates data to the PoE enabled sensors 302f and 302g via the connections between the three sensors illustrated in FIG. 7.

In one embodiment illustrated by FIG. 7, the PoE enabled sensor 302a is coupled to the PD circuitry 708 by the connection 704. According to this embodiment, the PoE enabled sensor 302a and the PD circuitry 708 communicate data via the connection 704. The data communicated between the PoE enabled sensor 302a and the PD circuitry 708 may include information descriptive of the environment of the PoE enabled sensor 702 as described below.

In this embodiment, the PD circuitry 708, in turn, is coupled to the PoE injector 706 by the connection 710. The PD circuitry 708 communicates data to the PoE injector 706 via the connection 710. In addition, in this embodiment, PoE injector 706 is coupled to the sensing circuitry 108 by the connection 118. The PoE injector 706 supplies power to drive the operation of the sensing circuitry 108 via the connection 118. Also, according to this embodiment, the PoE injector 706 and the sensing circuitry 108 communicate data via the connection 118. This data may be descriptive of any physical phenomenon detectable by the sensing circuitry 108. Examples of detectable physical phenomenon include temperature, humidity, vibration, ambient light levels, and other physical phenomenon.

In this embodiment, the PoE injector 706 is coupled to the PSE circuitry 110 by the connection 116. The PoE injector 706 supplies power and communicates data to the PSE circuitry 110 via the connection 116. The PSE circuitry 110, in turn, supplies power and communicates data to the PoE enabled sensor 302f via the connection 114. Also, in this embodiment, the PoE injector 706 is coupled to the PSE circuitry 304 by the connection 308. The PoE injector 706 supplies power and communicates data to the PSE circuitry 304 via the connection 308. The PSE circuitry 304, in turn, supplies power and communicates data to the PoE enabled sensor 302g via the connection 310.

Also, in this embodiment, the grid power 602 is coupled to the PoE injector 706 by the connection 606. As shown in FIG. 7, the grid power 602 supplies power to drive the operation of the PoE injector 706 via the connection 606.

PoE injector functionality may be integrated into some or all of the sensors, allowing supplemental power to be supplied at any convenient point without a separate injector device.

Any of the sensor networks described herein may implement a variety of networking standards including Ethernet and Power over Ethernet standards. Moreover, embodiments may include one or more pieces of PoE PSE and may control the provision of PoE power to the sensors using a version (e.g., version 2) of the CISCO ENERGYWISE protocol, as defined by Cisco Systems, Inc. of San Jose, Calif. In several embodiments, the sensor networks disclosed herein may be controlled by one or more PoE management systems, such as the energy management system 100 as described within U.S. Pat. No. 8,606,407, titled “ENERGY MANAGEMENT GATEWAYS AND PROCESSES,” issued Dec. 10, 2013, which is hereby incorporated herein by reference in its entirety.

It is appreciated that various features of the embodiments disclosed herein may be combined with other features in any combination. For example, the super capacitor may be added to any of the embodiments disclosed herein to provide backup or additional power for operations executed by PoE enabled sensors as needed. In addition, internal or external batteries may be included in any of the embodiments disclosed herein to provide backup or additional power. Moreover, various PoE enabled sensors may be configured to charge these internal or external batteries using PoE power provided to the PoE enabled sensors.

Sensors in a network generally provide at least 2 functions: 1) to sense the environment and report data and 2) to provide a communication path back to the root for descendant nodes in the network. The loss of a node in the network results in loss of communication for all its descendants as well as the failed node. As used herein, “criticality” is the number of nodes lost due to a single failure. Therefore, criticality=number of descendants+1.

In a tree structured network, criticality of any subtree is simply the size (i.e., number of nodes) in the subtree. To determine the expected criticality of a random failure in a tree, the average criticality of its subtrees can be calculated. Computing the expected criticality of perfect binary trees illustrates the advantages of tree-structured sensor networks.

For example, given a perfect binary tree T, of height H, containing N nodes, it is known that: N=2^{H}−1, and H=log₂ (N+1). There are 2^{h} nodes at any level h in the tree, for 0≦h≦H−1. Therefore, there are also 2^{h} subtrees rooted at any level h. The convention level h=0 is the root node. If S_{T} is the size of tree T and Sₕ is the size of any individual subtree of T at level h, then: Sₕ=*(2^{H-h}−1) for 0≦h≦H−1.

Cₐ is the average size of the subtrees of T and is calculated by summing the size of all the subtrees of T and then dividing by the number of nodes. For example, in computing the sum (Sₛᵤₘ) of the sizes of all subtrees:

$$\begin{matrix}{S}_{sun} = {\sum }_{i = 0}^{H - 1} [ {2}^{i} \cdot ( {2}^{H - i} - 1 ) ] \\ = Σ ( {2}^{i} \cdot {2}^{H - i} - {2}^{i} ) \\ = Σ ( {2}^{H} - {2}^{i} ) \\ = Σ {2}^{H} - Σ {2}^{i} .\end{matrix}$$

As can be seen above, there are H terms in the series, therefore:

$$\begin{matrix}{S}_{sum} = H {2}^{H} - {Σ2}^{i} \\ = H {2}^{H} - ( {2}^{0} + {2}^{1} + {2}^{2} + … + {2}^{h - 2} + {2}^{H - 1} ) \\ = H {2}^{H} - ( {2}^{H} - 1 ) - H {2}^{H} - {2}^{H} + 1 \\ = ( H - 1 ) \cdot {2}^{H} + 1\end{matrix}$$

Sₛᵤₘ is then divided by the number of nodes to obtain the average subtree size (Cₐ) given by:

$${C}_{a} = \frac{( H - 1 ) {2}^{H} + 1}{{2}^{H} - 1}$$

For large values of H, this approximates to:

$$\begin{matrix}{C}_{a} ≅ \frac{( H - 1 ) {2}^{H}}{{2}^{H}} \\ = H - 1 \\ = {log}_{2} ( N + 1 ) - 1\end{matrix}$$

In a linear daisy chain (i.e. flat arrangement) of N sensors where the sensors are enumerated from 1 (last) to N (first), a failed sensor at position n will delete n sensors from the chain, which is the criticality of node n. To determine the expected node loss from a random failure in the linear daisy chain, the average criticality of the nodes in the chain may be computed. For example, the sum of the criticality of all nodes is given by:

$$\begin{matrix}{S}_{sum} = {\sum }_{i = 1}^{N} i \\ = 1 + 2 + 3 + … + N \\ = ( N + 1 ) ( \frac{N}{2} ) \\ = \frac{{N}^{2} + N}{2}\end{matrix}$$

Sₛᵤₘ is then divided by the number of nodes to compute the average criticality of the chain:

$$\begin{matrix}{S}_{a} = \frac{{N}^{2} + N}{2 N} \\ = \frac{N + 1}{2}\end{matrix}$$

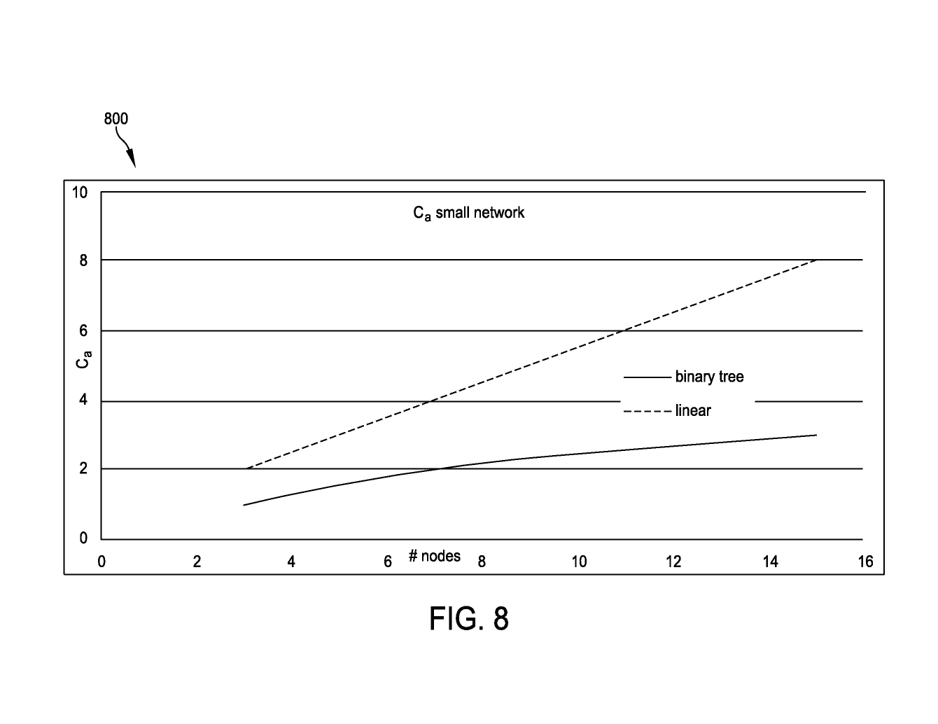

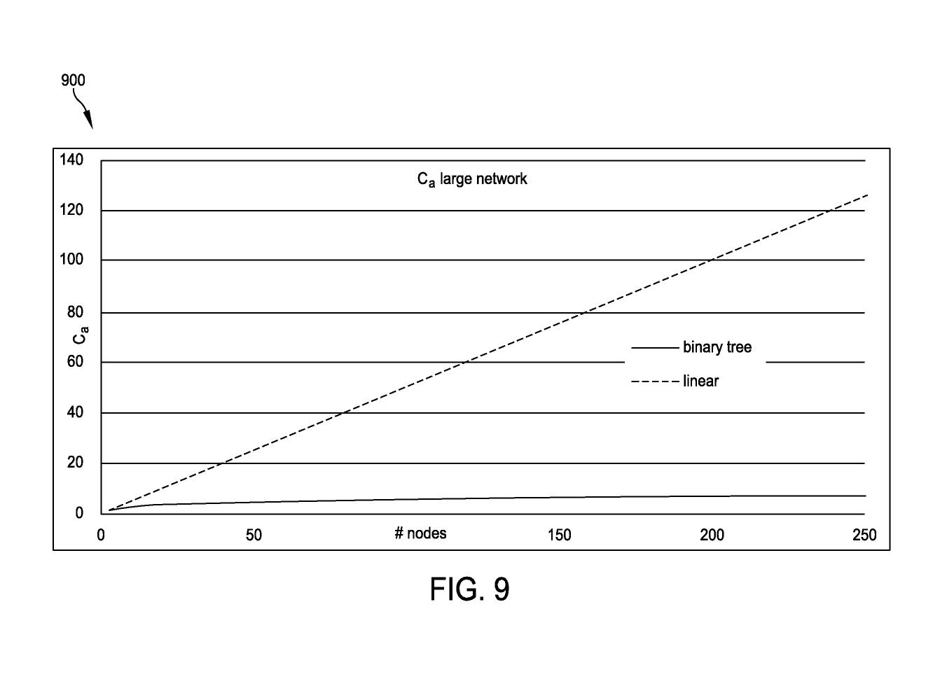

This result shows that a random failure in a linear chain will delete about half the nodes in a chain, in a large set of sample failures. It also compares unfavorably with the binary tree calculations shown above, growing linearly with N, rather than logarithmically with N as does the binary tree. A comparison of growth of Cₐ vs. node count in a small linear network and a binary tree network is shown in the graph 800 of FIG. 8. A comparison of growth of Cₐ vs. node count in a large linear network and a binary tree network is shown in the graph 900 of FIG. 9.

Typically, a linear sensor network has three components in each sensor: input power & data from the previous sensor in the chain, output power & data to the following sensor in the chain, and the sensing circuitry including microprocessor and other supporting hardware. In at least some embodiments, a binary tree-structured sensor network has an additional set of output power & data. That additional circuitry may provide additional opportunities for failure. However, the additional opportunities for failure may be outweighed by the added stability of a tree-structured network.

For example, using Mean Time Between Failure (MTBF) as the reliability estimate for a network node, MTBF_{L} denotes the MTBF of a linear node and MTBF_{B} denote the same on a binary tree node. A reliability factor kᵣ relates the two:

kᵣ·MTBF_{B}=MTBF_{L}.

k_{eq} is the ratio of

$$\frac{{MTBF}_{L}}{{MTBF}_{B}}$$

(i.e., the specific value of kᵣ) that provides equal expected node losses in each of the network architectures over time.

As discussed above, the expected loss from a single failure in a binary tree network of height H is H−1, while the expected loss in a linear network of the same size will be

$$\frac{( {2}^{H} - 1 ) + 1}{2} = {2}^{H - 1} .$$

The number of failures expected in a given time period T, for a node with reliability MTBF, is

$$\frac{T}{MTBF} .$$

Accordingly, the value of kᵣ=k_{eq} that will equalize performance of the two architectures is given by:

$$( H - 1 ) \cdot {k}_{eq} \cdot {MTBF}_{B} = {2}^{H - 1} \cdot {MTBF}_{L}$$

$${k}_{eq} = \frac{{2}^{H - 1}}{H - 1} \cdot ( \frac{{MTBF}_{L}}{{MTBF}_{B}} ) .$$

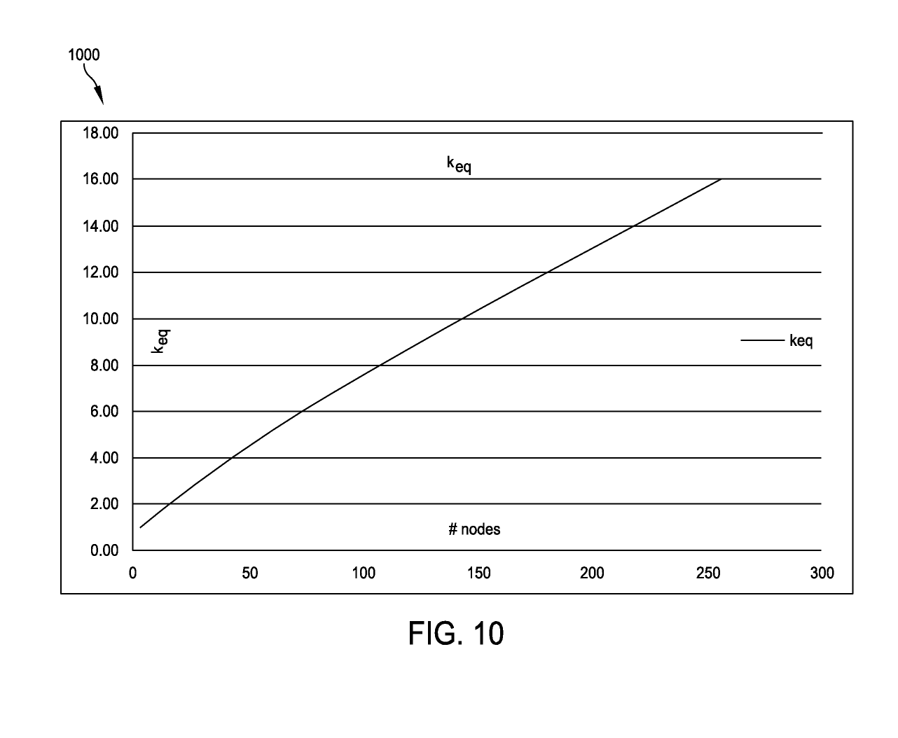

FIG. 10 is a graph 1000 illustrating the relationship between network size and the value of k_{eq} required to render a tree-structured network less attractive than a linear network. As shown in FIG. 10, the MTBF of binary tree nodes needs to be much worse than the linear nodes before the binary network shows more expected losses. The larger the network the more this is true.

The likelihood of a single random failure causing the loss of N or more nodes in a network can be estimated. In a linear network, there is one node whose failure will cause a loss of N nodes, and N nodes that will cause a loss of at least one node. In general, the probability of losing at least n nodes from a random failure in a linear network is given by:

$$\frac{N - ( n - 1 )}{N} for 1 \leq n \leq N .$$

As discussed above, a binary tree of height H has levels labeled from 0 to H−1. In a binary tree network, the loss of a single node causes the loss of its entire subtree. Accordingly, a binary tree network can be analyzed in terms of lost subtrees. At any level h in a tree T of height H, there is one tree Tₕ leading to level h that has height h+1 and a set of 2^{h} trees having height H−h descending from that level. Any node lost at level h will cause a loss of (at least) 2^{H-h}−1 nodes in the failed subtree. Accordingly, there is the number of nodes 2^{h+1}−1 that can cause a loss of at least 2^{H-h}−1 nodes, yielding the probability

$$\frac{{2}^{h + 1} - 1}{{2}^{H} - 1} = \frac{{2}^{h + 1} - 1}{N}$$

that a failure will cause a loss of at least 2^{H-h}−1 nodes.
If n is the number of nodes at risk, then:

n=2^{H-h}−1

n+1=2^{H-h}

log₂(n+1)=H−h

log₂(n+1)=log₂(N+1)−h

h=log₂(N+1)−log₂(n+1)

h+1=log₂(N+1)−log₂(n+1)+1.

The probability that a single failure will cause a loss of at least n nodes is given by:

$$\frac{{2}^{{log}_{2} ( N + 1 ) - {log}_{2} ( n + 1 ) + 1} - 1}{N} .$$

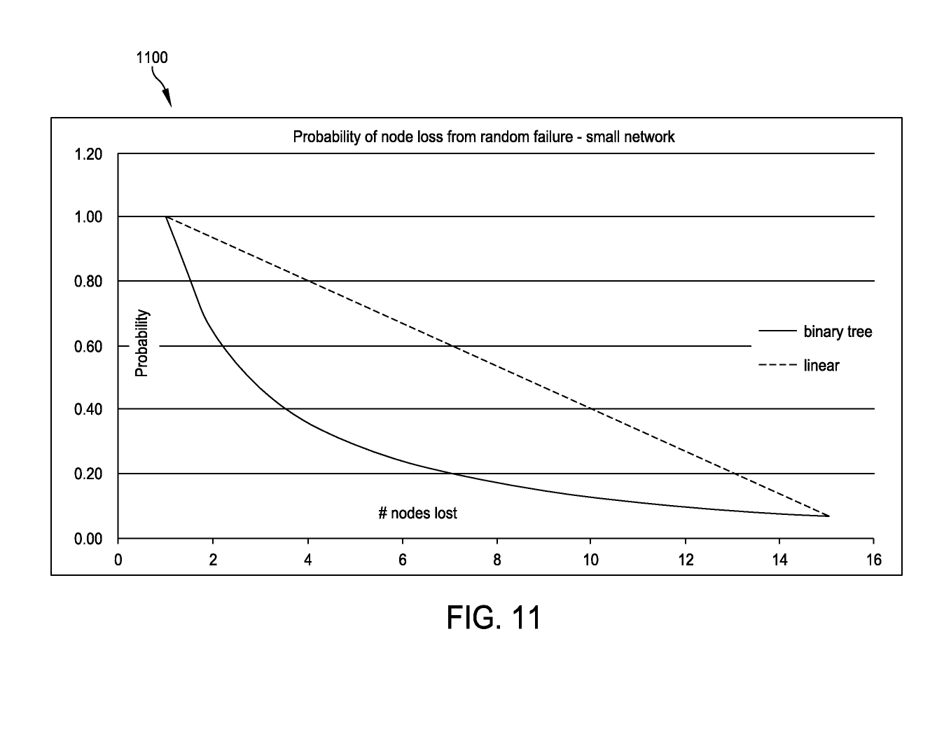

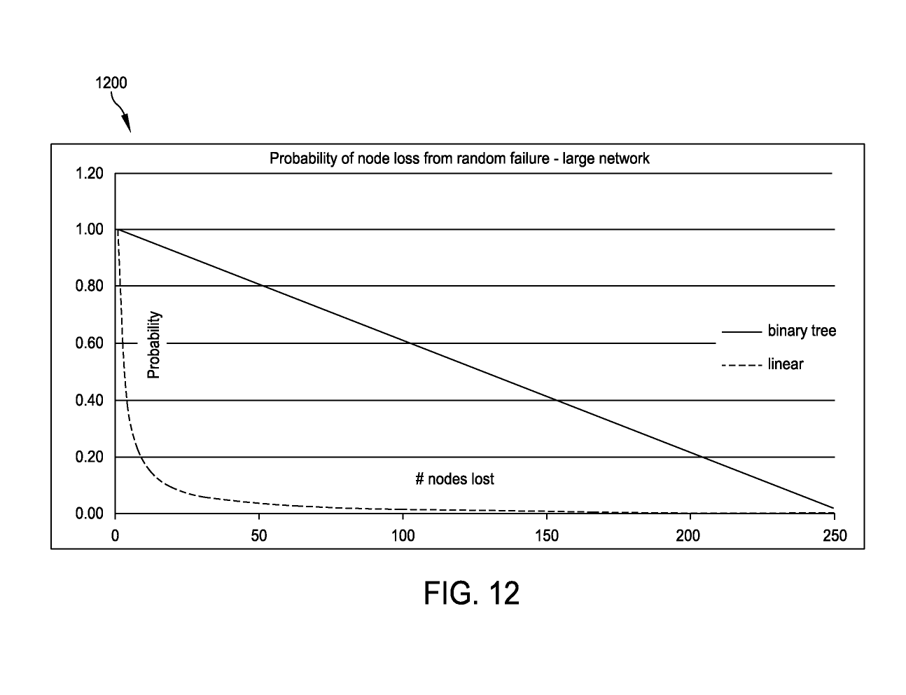

FIG. 11 is a graph 1100 illustrating a comparison of the probability of node losses from a single failure in a small (e.g. N=15) linear network and a small binary tree network. The graph 1100 illustrates the probability that at least n nodes will be lost. FIG. 12 is a graph 1200 illustrating a comparison of the probability of node losses from a single failure in a large (e.g. N=255) linear network and a large binary tree network. The graph 1200 illustrates the probability that at least n nodes will be lost. As shown in FIGS. 11 and 12, the probability is one (i.e., a certainty) that at least one node is lost from a failure, in both the linear network and binary tree network. Likewise, in both cases there is only one node that can cause the loss of the entire network. The probability of this occurring is 1/N.

Having thus described several aspects of at least one embodiment, it is to be appreciated that various alterations, modifications, and improvements will readily occur to those skilled in the art. In addition, examples and embodiments disclosed herein may also be used in other contexts. Such alterations, modifications, and improvements are intended to be part of this disclosure, and are intended to be within the scope of the examples and embodiments discussed herein. Accordingly, the foregoing description and drawings are by way of example only.

What is claimed is:

1. A power over Ethernet (“PoE”) sensor comprising:
a housing;
sensing circuitry disposed within the housing and configured to detect a physical phenomenon outside the housing;
at least one internal power source equipment (“PSE”) circuit disposed within the housing and configured to transmit PoE power and data to at least one downstream sensor; and
powered device (“PD”) circuitry disposed within the housing, coupled to the sensing circuitry and the at least one internal PSE circuit, and configured to:
receive PoE power and data from at least one element of PSE external to the housing;
transmit PoE power to the sensing circuitry to initiate operation of the sensing circuitry; and
transmit PoE power and data to the at least one internal PSE circuit to initiate transmission of PoE power and data to the at least one downstream sensor.

2. The PoE sensor of claim 1, wherein the sensing circuitry is further configured to transmit data corresponding to the physical phenomenon to the at least one internal PSE circuit and the PD circuitry.

3. The PoE sensor of claim 1, wherein the sensing circuitry is further configured to detect the physical phenomenon including at least one of temperature, humidity, vibration, and ambient light levels.

4. The PoE sensor of claim 1, wherein the PD circuitry is further configured to transmit data to the at least one element of PSE external to the housing.

5. The PoE sensor of claim 1, wherein the at least one internal PSE circuit includes:
a first internal PSE circuit coupled to the PD circuitry and the sensing circuitry, the first internal PSE circuit configured to transmit PoE power and data to a first downstream sensor; and
a second internal PSE circuit coupled to the PD circuitry and the sensing circuitry, the second internal PSE circuit configured to transmit PoE power and data to a second downstream sensor.

6. The PoE sensor of claim 1, wherein the at least one internal PSE circuit is further configured to receive data from the at least one downstream sensor.

7. The PoE sensor of claim 6, wherein the at least one internal PSE circuit is further configured to transmit data received from the at least one downstream sensor to the PD circuitry.

8. The PoE sensor of claim 1, further comprising:
a super capacitor coupled to the PD circuitry, the at least one internal PSE circuit, and the sensing circuitry, wherein the super capacitor is configured to supplement the PoE power transmitted by the PD circuitry to the at least one internal PSE circuit and the sensing circuitry.

9. The PoE sensor of claim 1, wherein the PD circuitry is further configured to receive PoE power derived from a backup power source.

10. The PoE sensor of claim 1, further comprising a PoE injector coupled to the PD circuitry, the sensing circuitry, and the at least one internal PSE circuit,
wherein the PoE injector is configured to receive mains power from a mains power source and transmit the mains power to the sensing circuitry and the at least one internal PSE circuit.

11. The PoE sensor of claim 10, wherein the PoE injector is further configured to communicate data between the PD circuitry and at least one of the sensing circuitry and the at least one internal PSE circuit.

12. The PoE sensor of claim 1, wherein the PD circuitry is further configured to receive PoE power from an external PoE injector and to transmit data to an upstream sensor via the external PoE injector.

13. The PoE sensor of claim 12, wherein the PD circuitry is further configured to transmit data to an upstream sensor via the external PoE injector.

14. A sensor network comprising:
a plurality of PoE sensors, each PoE sensor comprising:
a housing;
sensing circuitry disposed within the housing and configured to detect a physical phenomenon outside the housing;
at least one internal PSE circuit disposed within the housing and coupled to the sensing circuitry; and
PD circuitry disposed within the housing and coupled to the sensing circuitry and the at least one internal PSE circuit,
wherein the at least one internal PSE circuit is configured to be coupled to the PD circuitry of at least one downstream PoE sensor of the plurality of PoE sensors and to transmit PoE power and data to the at least one downstream PoE sensor of the plurality of PoE sensors, and
wherein the PD circuitry is configured to be coupled to the at least one internal PSE circuit of an upstream PoE sensor of the plurality of PoE sensors, and is further configured to:
receive PoE power and data from the at least one internal PSE circuit of the upstream PoE sensor;
transmit PoE power to the sensing circuitry to initiate operation of the sensing circuitry; and
transmit PoE power and data to the at least one internal PSE circuit to initiate transmission of PoE power and data to the at least one downstream PoE sensor of the plurality of PoE sensors.

15. The sensor network of claim 14, wherein the plurality of PoE sensors are coupled together in a binary tree configuration.

16. The sensor network of claim 14, further comprising a backup power source coupled to the PD circuitry of at least one of the plurality of PoE sensors, wherein the PD circuitry of the at least one of the plurality of PoE sensors is configured to receive PoE power derived from the backup power source.

17. The sensor network of claim 14, further comprising:
a mains power source; and
a PoE injector coupled to the mains power source, the at least one internal PSE circuit of a first one of the plurality of PoE sensors, and the PD circuitry of a second one of the plurality of PoE sensors,
wherein the at least one internal PSE circuit of the first one of the plurality of PoE sensors is configured to provide a reduced power PoE signal to the PoE injector, and
wherein the PoE injector is configured to receive mains power from the mains power source and provide a full strength PoE signal to the PD circuitry of the second one of the plurality of PoE sensors derived from the mains power and the reduced power PoE signal.

18. The sensor network of claim 17, wherein the PoE injector is further configured to communicate data between the at least one internal PSE circuit of the first one of the plurality of PoE sensors and the PD circuitry of the second one of the plurality of PoE sensors.

19. The sensor network of claim 14, wherein at least one of the plurality of PoE sensors further comprises a super capacitor coupled to the PD circuitry, the at least one internal PSE circuit, and the sensing circuitry, and wherein the super capacitor is configured to supplement the PoE power transmitted by the PD circuitry to the at least one internal PSE circuit and the sensing circuitry.

20. A PoE sensor comprising:
a housing;
sensing circuitry disposed within the housing and configured to detect a physical phenomenon outside the housing;
PD circuitry disposed within the housing and coupled to the sensing circuitry, the PD circuitry configured to:
receive PoE power and data from at least one element of PSE external to the housing; and
transmit PoE power to the sensing circuitry to initiate operation of the sensing circuitry; and
means for incorporating PoE extender capability into the PoE sensor such that the PoE sensor is configured to transmit PoE power and data to another downstream PoE sensor.
